(19) United States
(12) Patent Application Publication
(10) Pub. No.: US 2026/0139858 A1
(43) Pub. Date: May 21, 2026

(54) MANUFACTURING SYSTEM

(71) Applicant: HONDA MOTOR CO., LTD., Tokyo (JP)

(72) Inventors: Kenta Kasano, Wako-shi (JP); Hiroshi Akutsu, Wako-shi (JP); Atsuhiro Nishida, Wako-shi (JP)

(21) Appl. No.: 19/389,242

(22) Filed: Nov. 14, 2025

(30) Foreign Application Priority Data
Nov. 19, 2024 (JP) 2024-201934

(51) Int. Cl. F24F 7/06; B01D 46/00; B01D 53/26; F24F 7/00; H01M 10/04

(52) U.S. Cl. CPC F24F 7/06; B01D 46/003; B01D 46/0045; B01D 53/26; H01M 10/0404; B01D 2257/80; B01D 2258/06; B01D 2273/30; F24F 2007/001

(57) ABSTRACT

A manufacturing system includes: an enclosure that is maintained at a predetermined dew point; a manufacturing apparatus of a solid-state battery, the manufacturing apparatus being stored in an inside of the enclosure; and a fan that is provided at a position exposed to an outside of the enclosure and discharges air at the inside of the enclosure to the outside of the enclosure.

### CROSS-REFERENCE TO RELATED APPLICATION

Priority is claimed on Japanese Patent Application No. 2024-201934, filed on Nov. 19, 2024, the contents of which are incorporated herein by reference.

### BACKGROUND

### Field Of The Invention

The present invention relates to a manufacturing system that manufactures a solid-state battery.

### Background

In the related art, in order to maintain the environment of a manufacturing line that manufactures a solid-state battery to be at a low dew point, an enclosure is constituted by sealing a manufacturing apparatus and a process apparatus with a panel such as an acrylic plate. Further, in order to perform air conditioning for the inside of the enclosure, a fan is also provided in the inside of the enclosure.

For example, Korean Patent Application, Publication No. 10-2022-0046333 discloses an air circulation system for secondary battery manufacturing which includes a clean booth that accommodates a secondary battery manufacturing apparatus in the inside of the clean booth, a main filter unit that is connected to the clean booth and suctions and decomposes a harmful gas generated at the inside of the clean booth, a dry room that accommodates the clean booth and the main filter unit, maintains a constant humidity at the inside of the dry room, and is configured so that air having a constant humidity flows into the clean booth, and a dehumidification unit that is arranged at the outside of the dry room and is configured so as to maintain a constant humidity in the dry room.

### SUMMARY

However, in the related art, there is still room for improvement from the viewpoint of maintaining an internal space of a clean booth to be in a desired atmosphere.

A problem to be solved by the present invention is to provide a manufacturing system capable of maintaining an internal space of an enclosure to be in a desired atmosphere over a long period.

A manufacturing system according to a first aspect of the present invention includes: an enclosure that is maintained at a predetermined dew point; a manufacturing apparatus of a solid-state battery, the manufacturing apparatus being stored in an inside of the enclosure; and a fan that is provided at a position exposed to an outside of the enclosure and discharges air at the inside of the enclosure to the outside of the enclosure.

According to the first aspect, since the fan is provided at a position exposed to the outside of the enclosure, heat generated at the time of operation of the fan is easily dissipated to the outside of the enclosure. Therefore, the heat of the fan is prevented from being transmitted to the inside of the enclosure, and an internal space of the enclosure is easily maintained under a desired atmosphere for a long period of time. Further, the fan as a device for which it is assumed to periodically perform a maintenance or an inspection is provided to be exposed to the outside of the enclosure in advance. According to this configuration, since it becomes possible to perform the work of the maintenance or the inspection of the fan from the outside of the enclosure, the effort for a worker to enter and leave the inside of the enclosure is eliminated. Therefore, it is possible to prevent air in an external space of the enclosure from entering the internal space of the enclosure and prevent the dew point of the internal space of the enclosure from increasing at each time of the maintenance. As a result, it is possible to improve the maintenance property and maintain the inside of the enclosure to be at a low dew point.

A second aspect is the manufacturing system according to the first aspect described above, wherein the fan may be provided at the outside of the enclosure at a position away from the enclosure and may be connected to the inside of the enclosure via a duct.

According to the second aspect, since the fan and the enclosure are connected via the duct, the fan and the enclosure can be separated to a desired position. Thereby, it is possible to prevent the impact of the heat of the fan from reaching the internal space of the enclosure. Further, since it is also possible to prevent an abrasion powder generated at the time of operation of the fan, dust that is present in the external space of the enclosure, or the like from entering the internal space of the enclosure, the internal space of the enclosure is easily maintained to be under a desired atmosphere for a long period of time.

A third aspect is the manufacturing system according to the second aspect described above which may include: the fan and a plurality of ducts each of which is the duct, wherein the plurality of ducts may be connected to the single fan.

According to the third aspect, the number of fans can be reduced as compared with the case where the fan is provided on each duct.

A fourth aspect is the manufacturing system according to the second aspect described above which may include: a plurality of fans each of which is the fan and a plurality of ducts each of which is the duct, wherein each of the plurality of fans may be connected to each of the plurality of ducts.

According to the fourth aspect, even when an individual fan fails, another fan can normally operate, and continuous operation becomes possible. Further, the dew point is managed individually by filter absorption, and when there is a degradation impact or degradation is detected by a sensor, it is also possible to increase the operation of the fan only at a location where there is an impact regardless of whether the location is upstream or downstream.

A fifth aspect is the manufacturing system according to any one of the second to fourth aspects described above, wherein a filter may be provided in the duct on a portion located closer to the enclosure than the fan.

According to the fifth aspect, moisture, dust, and the like can be trapped in the process in which air passes through the inside of the duct. Thereby, it is possible to prevent moisture, dust, and the like that remain in the duct from entering the internal space of the enclosure again, and the internal space of the enclosure is easily maintained to be under a desired atmosphere for a long period of time.

A sixth aspect is the manufacturing system according to the fifth aspect described above, wherein the filter may be a replaceable dehumidification filter.

According to the sixth aspect, it is possible to recover a dehumidification function without replacing the fan or the duct. Thereby, it is possible to improve the maintenance property.

A seventh aspect is the manufacturing system according to any one of the first to sixth aspects described above, wherein the manufacturing apparatus may include a plurality of process portions that are provided and aligned in a transportation direction of the solid-state battery, in the plurality of process portions, the size in an intersection direction that intersects the transportation direction may be different from each other, and the size in the intersection direction of the enclosure may be different depending on a position in the transportation direction in accordance with the shape of a process portion of the plurality of process portions.

According to the seventh aspect, for example, as compared with the case where the enclosure is formed in a rectangular parallelepiped shape by fitting the size in the intersection direction to the maximum size of the process portion, the volume of the enclosure can be made small. Thereby, space saving of the manufacturing system becomes possible. Further, a space for which an atmosphere management is required can be made small, and therefore, reduction of the size, improvement of the maintenance property, and the like of an apparatus required for the atmosphere management also become possible.

According to each aspect described above, it is possible to maintain the internal space of the enclosure to be in a desired atmosphere over a long period.

### BRIEF DESCRIPTION OF THE DRAWINGS

FIG. 1 is a cross-sectional view showing a cross section of a solid-state battery according to a first embodiment.

FIG. 2 is a perspective view showing a manufacturing system according to the first embodiment.

FIG. 3 is a plan cross-sectional view showing part of the manufacturing system according to the first embodiment.

FIG. 4 is a perspective view showing an example of a filter of the manufacturing system according to the first embodiment.

FIG. 5 is a plan view showing part of a manufacturing system according to a second embodiment.

### DESCRIPTION OF EMBODIMENTS

### First Embodiment

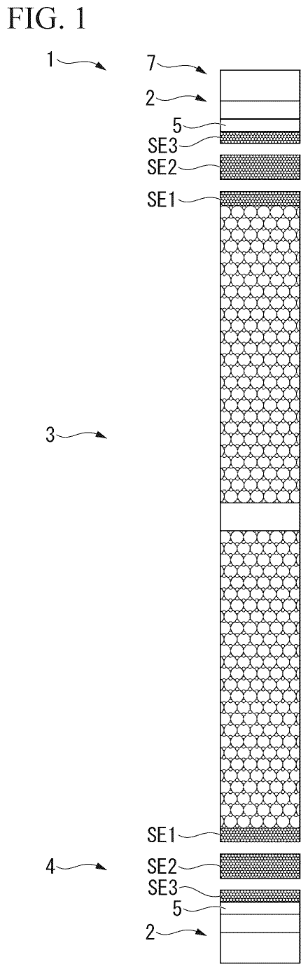

A manufacturing system of a solid-state battery according to a first embodiment of the present invention will be described with reference to FIG. 1 to FIG. 4.

### Solid-State Battery 1

First, with reference to FIG. 1, a solid-state battery 1 manufactured by a manufacturing system 10 according to the present embodiment is described. FIG. 1 is a cross-sectional view showing a cross section of the solid-state battery 1 according to the present embodiment.

As shown in FIG. 1, the solid-state battery 1 is an all-solid-state battery having an electrode 7 in which a negative electrode layer 2, a solid electrolyte layer 4, a positive electrode layer 3, a solid electrolyte layer 4, and a negative electrode layer 2 are laminated in this order. However, the structure of the solid-state battery 1 is not limited to the above structure. The solid-state battery 1 may have a configuration that is capable of being used in a solid-state battery such as an exterior body other than the electrode 7.

The solid electrolyte layer 4 in the solid-state battery 1 has at least a first solid electrolyte layer SE1 arranged on the positive electrode layer 3 side and a negative electrode side solid electrolyte layer SE3 arranged on the negative electrode layer 2 side. The solid electrolyte is constituted of an inorganic solid electrolyte such as a sulfide system electrolyte, and it is necessary to manage a dew point such that the solid electrolyte does not react with moisture. The solid electrolyte layer 4 may have a second solid electrolyte layer SE2 arranged adjacent to the first solid electrolyte layer SE1. Further, an intermediate layer 5 may be arbitrarily arranged between the negative electrode layer 2 and the solid electrolyte layer 4.

The solid-state battery 1 is not particularly limited but may be a lithium-ion solid-state secondary battery or may be a lithium metal secondary battery.

### Manufacturing Process of Solid-State Battery 1

Next, main manufacturing processes of the solid-state battery 1 are described. The process of manufacturing the solid-state battery 1 mainly includes an electrode manufacturing process and an assembly process.

The electrode manufacturing process has a kneading process of mixing an active material (battery metal), a conductive auxiliary agent, a binder, a solid electrolyte, and the like, and a coating process of coating the kneaded material on a base material such as a metal foil. It is necessary to dry the material after the coating.

The assembly process has a roll press process of smoothing a surface by compressing the coated material and forming the electrode 7 by integrating the negative electrode layer 2 and the positive electrode layer 3, and a cut process of cutting the electrode 7 for processing the electrode 7 to a predetermined size.

Further, the assembly process has a lamination process of forming the solid-state battery 1 by laminating the plurality of electrodes 7, and an end insulation process of insulating an end portion of the laminated solid-state battery 1 by performing UV coating.

Further, the assembly process has a joint process of joining a tab that functions as an electric power collection terminal to the plurality of electrodes 7 on which the UV coating is performed, and a lamination process of sealing the solid-state battery 1 by performing lamination molding.

### Manufacturing System 10

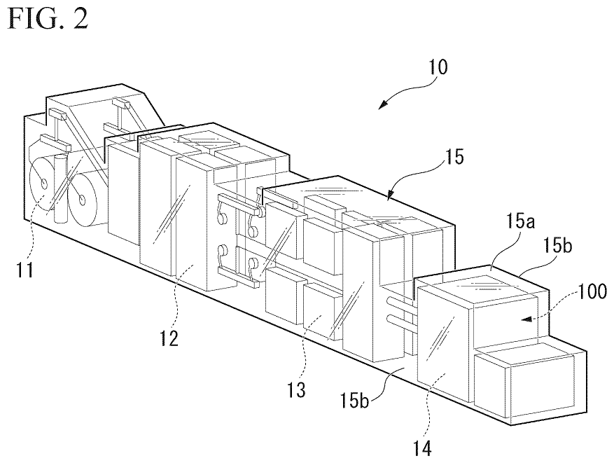

Next, the manufacturing system 10 of a solid-state battery according to the present embodiment is described with reference to FIG. 2 to FIG. 4. FIG. 2 is a perspective view showing the manufacturing system 10 according to the present embodiment.

As shown in FIG. 2, the manufacturing system 10 mainly performs the assembly process among the manufacturing processes described above. The manufacturing system 10 includes a manufacturing apparatus 100 of the solid-state battery 1, which has a plurality of process portions provided and aligned in a transportation direction of the solid-state battery 1. The manufacturing apparatus 100 includes, as a process portion, at least a wind-off machine 11, a roll press portion 12, a cut-lamination portion 13, and an end insulation portion 14. In these process portions, the size in an intersection direction (an upward-downward direction or a width direction) that intersects a transportation direction of the solid-state battery 1 is different depending on the process portion.

Further, the manufacturing system 10 includes an enclosure 15 that covers the manufacturing apparatus 100 and thereby stores the entire manufacturing apparatus 100 in the inside of the enclosure 15. The enclosure 15 partitions an internal space as an operation environment of the manufacturing apparatus 100 and an external space. The internal space of the enclosure 15 is maintained to be in an atmosphere having a low dew point (for example, −60° C. or less). The dew point management in the internal space of the enclosure 15 may be performed independently by a dehumidification device (not shown) or may be performed by using dry air used by a pretreatment device (for example, a coating process or the like) of the manufacturing system 10. Further, air in which moisture, dust, contamination, and the like are removed via a filter 23 described later may be caused to return to the inside of the enclosure 15.

The wind-off machine 11 winds off the material of the solid-state battery 1 that passes through the coating process to a downstream side.

The roll press portion 12 laminates, for example, the negative electrode layer 2, the intermediate layer 5, the solid electrolyte layer 4, and the positive electrode layer 3 in this order and generates the electrode 7 by integrating the negative electrode layer 2 and the positive electrode layer 3 by roll pressing.

The cut-lamination portion 13 cuts the electrode 7 generated by the roll press portion 12 in order to process the electrode 7 into a predetermined size, and forms the solid-state battery 1 by laminating the plurality of electrodes 7 that are cut. In the solid-state battery 1, for example, 27 electrodes 7 can be laminated; however, the number of electrodes 7 to be laminated is not limited to this. Here, when a lamination body of the cut cell (electrode 7) is moved, a fan can be used in order to suction a workpiece (lamination body). In this case, even in the fan used in the suction, by providing the fan at the outside, a similar effect is satisfied.

The end insulation portion 14 insulates an end portion of the solid-state battery 1 laminated by the cut-lamination portion 13 by performing UV coating that uses, for example, a coating material which is reacted and cured by ultraviolet irradiation and cures the coating material in a few seconds by ultraviolet irradiation of a UV lamp.

The enclosure 15 is formed, for example, by using a material having optical transparency such as an acrylic plate, and the size in the intersection direction of the enclosure 15 is different depending on a position in the transportation direction in accordance with the shape of each process portion. In an example shown in the drawing, at least a top wall 15a of the enclosure 15 is formed along an upper end position of each process portion. However, both side walls 15b in the width direction determined by a large-sized cell to be transported in the enclosure 15 may be formed along both end positions in the width direction of each process portion.

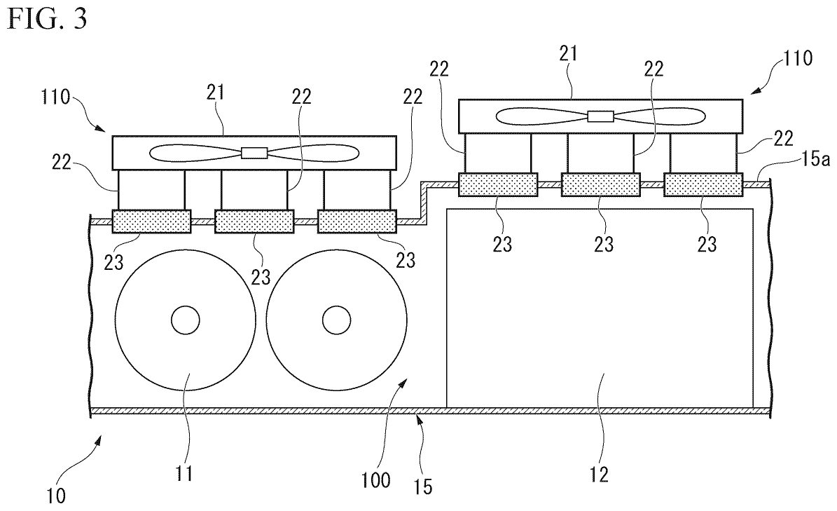

FIG. 3 is a side cross-sectional view showing part of the manufacturing system 10. FIG. 3 shows, as an example, a portion where the roll press portion 12 and the cut-lamination portion 13 are covered by the enclosure 15.

As shown in FIG. 3, the manufacturing system 10 includes an exhaust unit 110 that discharges air from the internal space of the enclosure 15. A plurality of exhaust units 110 are provided in the transport direction, for example, so as to correspond to each process portion. In the following description, details of the exhaust unit 110 will be described using a single exhaust unit 110 an example. The number, layout, and the like of the exhaust units 110 can be changed as appropriate.

The exhaust unit 110 includes a fan 21, a duct 22, and a filter 23.

The fan 21 suctions air at the inside of the enclosure 15 and discharges the air to the outside of the enclosure 15. At this time, the fan 21 can also suction moisture, dust, and the like at the inside of the enclosure 15 together with the air to be discharged. That is, the fan 21 has a function as an auxiliary device for maintaining the atmosphere in the internal space of the enclosure 15.

The fan 21 is provided at the outside of the enclosure 15 at a position away from the enclosure 15. Accordingly, the fan 21 is provided in a state of being exposed to the outside of the enclosure 15.

The duct 22 connects the fan 21 to the enclosure 15. A plurality of ducts 22 are provided, for example, to be spaced from each other in the transportation direction. A first end portion of each duct 22 communicates with the internal space of the enclosure 15 through the top wall 15a. On the other hand, a second end portion of each duct 22 is connected to the fan 21 via a merging duct (not shown) or the like. That is, in the exhaust unit 110 of the present embodiment, the plurality of ducts 22 are connected collectively to a single fan 21. The length of the duct 22 can be preferably set to, for example, such a length that the heat of the fan 21 does not transmit to the internal space of the enclosure 15 through the inside of the duct 22. Further, although not shown in the drawing, it is also possible to cause the air in which dust and moisture are adsorbed by the filter 23 to return to the inside of the enclosure 15 as appropriate.

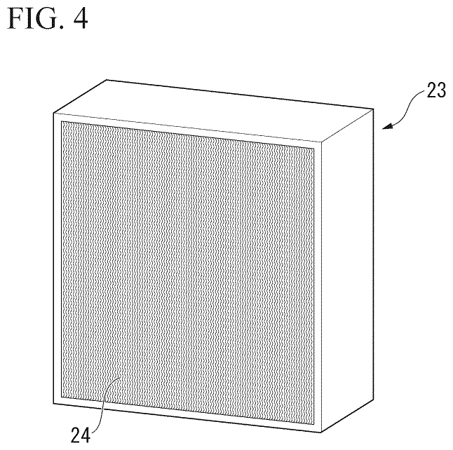

FIG. 4 is a perspective view showing an example of the filter 23 of the manufacturing system 10.

As shown in FIG. 4, the filter 23 is a so-called dehumidification filter. In the present embodiment, as the filter 23, for example, a filter (for example, a HEPA (High Efficiency Particulate Air) filter or the like) having a dehumidification function and a dust collection function can be used. Specifically, the filter 23 has a filter surface 24 that has a mesh form and traps moisture, dust, and the like while allowing passage of air.

The filter 23 is provided individually on each duct 22. The filter 23 is provided on the first end portion at the inside of the duct 22 so as to shield the inside of the duct 22 by the filter surface 24. The filter 23 is provided to be attachable and detachable (replaceable) with respect to each duct 22. In this case, the filter 23 may be attached and detached from the outside of the enclosure 15, for example, through an opening-closing door or the like of the duct 22, or may be attached and detached from the internal space of the enclosure 15. Further, the filter 23 may be provided, for example, on a connection portion or the like of the duct 22 in the top wall 15a of the enclosure 15 as long as the filter 23 has a configuration that partitions the fan 21 and the internal space of the enclosure 15.

In the manufacturing system 10 of the present embodiment, the assembly process is performed in a state where the internal space of the enclosure 15 is maintained to be at a low dew point as described above. At this time, by performing the assembly process while appropriately discharging the air in the internal space of the enclosure 15 by the exhaust unit 110, it is possible to continue the manufacturing of the solid-state battery 1 while discharging the air, dust, and the like that are present in the internal space of the enclosure 15 to the external space of the enclosure 15. In the manufacturing system 10, a measurement device of the dew point may be provided on each process portion, and the output of the fan 21 may be adjusted for each process portion.

In the manufacturing system 10 according to the present embodiment, since the fan 21 is provided at a position exposed to the outside of the enclosure 15, heat generated at the time of operation of the fan 21 is easily dissipated to the outside of the enclosure 15. Therefore, the heat of the fan 21 is prevented from being transmitted to the inside of the enclosure 15, and an internal space of the enclosure 15 is easily maintained under a desired atmosphere for a long period of time. Further, the fan 21 as a device for which it is assumed to periodically perform a maintenance or an inspection is provided to be exposed to the outside of the enclosure 15 in advance. According to this configuration, since it becomes possible to perform the work of the maintenance or the inspection of the fan 21 from the outside of the enclosure 15, the effort for a worker to enter and leave the inside of the enclosure 15 is eliminated. Therefore, it is possible to prevent air in an external space of the enclosure 15 from entering the internal space of the enclosure 15 and prevent the dew point of the internal space of the enclosure 15 from increasing at each time of the maintenance. As a result, it is possible to improve the maintenance property and maintain the inside of the enclosure 15 to be at a low dew point.

In the manufacturing system 10 according to the present embodiment, the fan 21 is provided at the outside of the enclosure 15 at a position away from the enclosure 15 and is connected to the inside of the enclosure 15 via a duct 22.

According to this configuration, since the fan 21 and the enclosure 15 are connected via the duct 22, the fan 21 and the enclosure 15 can be separated to a desired position. Thereby, it is possible to prevent the impact of the heat of the fan 21 from reaching the internal space of the enclosure 15. Further, since it is also possible to prevent an abrasion powder generated at the time of operation of the fan 21, dust that is present in the external space of the enclosure 15, or the like from entering the internal space of the enclosure 15, the internal space of the enclosure 15 is easily maintained to be under a desired atmosphere for a long period of time.

In the manufacturing system 10 according to the present embodiment, a plurality of ducts 22 are connected to a single fan 21.

According to this configuration, the number of fans 21 can be reduced as compared with the case where the fan 21 is provided on each duct 22.

In the manufacturing system 10 according to the present embodiment, a filter 23 is provided in the duct 22 on a portion located closer to the enclosure 15 than the fan 21.

According to this configuration, moisture, dust, and the like can be trapped in the process in which air passes through the inside of the duct 22. Thereby, it is possible to prevent moisture, dust, and the like that remain in the duct 22 from entering the internal space of the enclosure 15 again, and the internal space of the enclosure 15 is easily maintained to be under a desired atmosphere for a long period of time.

In the manufacturing system 10 according to the present embodiment, the filter 23 is a replaceable dehumidification filter.

According to this configuration, it is possible to recover a dehumidification function and a dust collection function without replacing the fan 21 or the duct 22. Thereby, it is possible to improve the maintenance property.

In the manufacturing system 10 according to the present embodiment, in the plurality of process portions, the size in an intersection direction that intersects the transportation direction is different from each other, and the size in the intersection direction of the enclosure 15 is different depending on a position in the transportation direction in accordance with the shape of a process portion.

According to this configuration, for example, as compared with the case where the enclosure 15 is formed in a rectangular parallelepiped shape by fitting the size in the intersection direction to the maximum size of the process portion, the volume of the enclosure 15 can be made small.

Thereby, space saving of the manufacturing system 10 becomes possible. Further, a space for which an atmosphere management is required can be made small, and therefore, reduction of the size, improvement of the maintenance property, and the like of an apparatus required for the atmosphere management also become possible.

### Second Embodiment

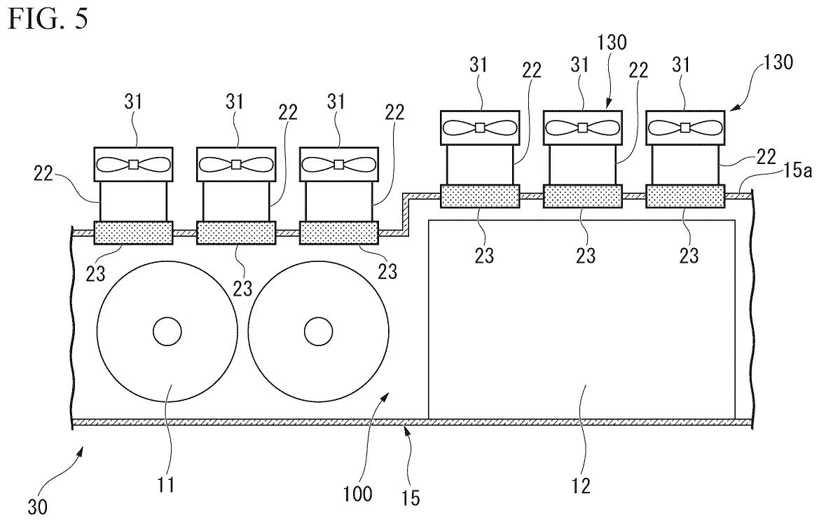

A configuration of a manufacturing system 30 according to a second embodiment is described with reference to FIG. 5. FIG. 5 is a plan view showing part of the manufacturing system 30 according to the present embodiment. The manufacturing system 30 according to the present embodiment is different from the manufacturing system 10 according to the first embodiment in that one fan 31 is connected to one duct 22. Other configurations are similar to those of the manufacturing system 10 according to the first embodiment.

As shown in FIG. 5, in an exhaust unit 130 in the manufacturing system 30, one duct 22 is individually connected to one fan 31. Further, in the manufacturing system 30, a filter 23 is provided in the duct 22 on a portion located closer to the enclosure 15 than the fan 31.

According to the manufacturing system 30 according to the present embodiment, it is possible to obtain effects similar to those of the manufacturing system 10 according to the first embodiment. Additionally, since one duct 22 is connected to one fan 31 in the manufacturing system 30, when the fan 31 is replaced, the replacement is easily performed, and the maintenance property is improved. Furthermore, since a small and inexpensive fan 31 can be used, the cost of the fan 31 per one fan can be reduced.

Further, by adjusting an output of each fan 31, it becomes easy to perform an atmosphere management in each area in the internal space of the enclosure 15.

Furthermore, even when any of a plurality of fans 31 fails, another fan 31 can normally operate, and continuous operation becomes possible. Further, since the filter 23 is provided on each fan 31, it is possible to individually manage the dew point by filter absorption. Therefore, when there is a degradation impact or degradation is detected by a sensor, it is also possible to increase the operation of the fan 31 only at a location where there is an impact regardless of whether the location is upstream or downstream.

Although embodiments of the present invention have been described, these embodiments have been presented as examples and are not intended to limit the scope of the invention. These embodiments can be implemented in a variety of other modes, and various omissions, combinations, substitutions, and changes can be made without departing from the scope of the invention. These embodiments and modifications thereof are included in the scope and gist of the invention and are also included in the scope of the invention described in the appended claims and equivalent thereof.

The above embodiment is described using a configuration in which the fan 21, 31 is provided at a position away from the enclosure 15; however, the embodiment is not limited to this configuration. At least part of the fan 21, 31 may be exposed to the outside from the enclosure 15. For example, the fan 21, 31 may be provided so as to penetrate through the top wall 15a or the side wall 15b of the enclosure.

In this case, the duct 22 is not an essential configuration.

The above embodiment is described using a configuration that includes the filter 23 as the exhaust unit 110, 130; however, the filter 23 is not an essential configuration.

The above embodiment is described using a configuration that includes a dehumidification function and a dust collection function as the filter 23; however, the embodiment is not limited to this configuration. The filter 23 may include a function (a deodorant function or the like) other than the dehumidification function and the dust collection function.

The above embodiment is described using a configuration in which the size in the intersection direction of the enclosure 15 is different depending on the position in the transportation direction in accordance with the shape of the process portion; however, the embodiment is not limited to this configuration. The size in the intersection direction of the enclosure 15 may be the size of a rectangular parallelepiped shape or the like having a size that matches the maximum size of any of the process portions.

The above embodiment is described using an example of the manufacturing system 10, 30 used in the assembly process in the manufacturing process of the solid-state battery 1; however, the embodiment is not limited to this configuration. The manufacturing system 10, 30 according to the present invention may be used in a process other than the assembly process.

What is claimed is:

1. A manufacturing system comprising:
an enclosure that is maintained at a predetermined dew point;
a manufacturing apparatus of a solid-state battery, the manufacturing apparatus being stored in an inside of the enclosure; and
a fan that is provided at a position exposed to an outside of the enclosure and discharges air at the inside of the enclosure to the outside of the enclosure.

2. The manufacturing system according to claim 1,
wherein the fan is provided at the outside of the enclosure at a position away from the enclosure and is connected to the inside of the enclosure via a duct.

3. The manufacturing system according to claim 2, comprising:
the fan and a plurality of ducts each of which is the duct,
wherein the plurality of ducts are connected to the single fan.

4. The manufacturing system according to claim 2, comprising:
a plurality of fans each of which is the fan and a plurality of ducts each of which is the duct,
wherein each of the plurality of fans is connected to each of the plurality of ducts.

5. The manufacturing system according to claim 2,
wherein a filter is provided in the duct on a portion located closer to the enclosure than the fan.

6. The manufacturing system according to claim 5, wherein the filter is a replaceable dehumidification filter.

7. The manufacturing system according to claim 1,
wherein the manufacturing apparatus comprises a plurality of process portions that are provided and aligned in a transportation direction of the solid-state battery,
in the plurality of process portions, a size in an intersection direction that intersects the transportation direction is different from each other, and
a size in the intersection direction of the enclosure is different depending on a position in the transportation direction in accordance with a shape of a process portion of the plurality of process portions.

8. The manufacturing system according to claim 3,
wherein a filter is provided in the duct on a portion located closer to the enclosure than the fan.

9. The manufacturing system according to claim 8,
wherein the filter is a replaceable dehumidification filter.

10. The manufacturing system according to claim 4,
wherein a filter is provided in the duct on a portion located closer to the enclosure than the fan.

11. The manufacturing system according to claim 10,
wherein the filter is a replaceable dehumidification filter.

12. The manufacturing system according to claim 2,
wherein the manufacturing apparatus comprises a plurality of process portions that are provided and aligned in a transportation direction of the solid-state battery,
in the plurality of process portions, a size in an intersection direction that intersects the transportation direction is different from each other, and
a size in the intersection direction of the enclosure is different depending on a position in the transportation direction in accordance with a shape of a process portion of the plurality of process portions.

13. The manufacturing system according to claim 3,
wherein the manufacturing apparatus comprises a plurality of process portions that are provided and aligned in a transportation direction of the solid-state battery,
in the plurality of process portions, a size in an intersection direction that intersects the transportation direction is different from each other, and
a size in the intersection direction of the enclosure is different depending on a position in the transportation direction in accordance with a shape of a process portion of the plurality of process portions.

14. The manufacturing system according to claim 4,
wherein the manufacturing apparatus comprises a plurality of process portions that are provided and aligned in a transportation direction of the solid-state battery,
in the plurality of process portions, a size in an intersection direction that intersects the transportation direction is different from each other, and
a size in the intersection direction of the enclosure is different depending on a position in the transportation direction in accordance with a shape of a process portion of the plurality of process portions.
